(19) United States
(12) Patent Application Publication
(10) Pub. No.: US 2009/0036128 A1
(43) Pub. Date: Feb. 5, 2009

(54) METHOD AND SYSTEM FOR DYNAMIC CALL ANCHORING

(75) Inventors: Masilamany RAGUPARAN, Dunrobin (CA); Boris ROZINOV, Richmond Hill (CA)

Correspondence Address: OGILVY RENAULT LLP, 1981 MCGILL COLLEGE AVENUE, SUITE 1600, MONTREAL, QC, H3A2Y3, CA

(73) Assignee: NEWSTEP NETWORKS INC., Toronto (CA)

(21) Appl. No.: 11/833,332

(22) Filed: Aug. 3, 2007

(51) Int. Cl. H04Q 7/20

(52) U.S. Cl. 455/436

(57) ABSTRACT

Calls to/from one or more devices operated by a subscriber are dynamically anchored as a need is imposed by mobility of the subscriber. A dynamic call anchoring client application that operates on the one or more devices operated by the subscriber may determine when criteria are satisfied for handover of a call in progress form an enterprise network to another network, or vice versa. Replaces functionality in a switch in the enterprise network is used to effect the dynamic call anchoring by replacing a call leg anchored in one of the networks with a call leg anchored in the other of the networks.

### CROSS-REFERENCE TO RELATED APPLICATIONS

This first filed application for this invention.

### MICROFICHE APPENDIX

Not Applicable.

### TECHNICAL FIELD

This application relates in general to the delivery of enhanced communications services and, in particular, to a method and system for dynamic call anchoring to conserve subscriber termination equipment resource and bandwidth requirements.

### BACKGROUND OF THE INVENTION

Providing enhanced communications services to subscribers served by a public branch exchange (PBX) telephone network requires routing all calls associated those subscribers, including intra-network calls, to a converged services node (CSN) in a Voice over Internet Protocol (VoIP) or an Internet Protocol Multimedia Subsystem (IMS) network. Routing all such calls to the CSN can tax hardware resources at the public branch exchange (PBX) and/or their Internet Protocol (IP) bandwidth. It is well known that only certain calls require enhanced communications services. However, it is impossible to predict in advance whether any particular call will require, or continue to require, the use of enhanced communications services.

There therefore exists a need for a method and system that permits calls to be dynamically anchored in the CSN only while a requirement for enhanced communications service features exists.

### SUMMARY OF THE INVENTION

It is therefore an object of the invention to provide a method and a system for dynamic call anchoring to limit PBX resource and IP bandwidth usage by dynamically anchoring calls in the CSN only while enhanced call services are required.

The invention therefore provides a method of dynamic call anchoring to support call continuity for a subscriber who roams between an enterprise network and another network, comprising: on call setup between a device operated by the subscriber and a device operated by another party, storing call context information about the call so that the call context information is available to be retrieved via a data network by an authorized application that requires the call context information when criteria are satisfied for a handover of the call form the enterprise network to the other network or from the other network to the enterprise network; when the criteria are satisfied, retrieving the call context information and formulating a call setup message to release the call from the one network and dynamically anchor the call in the other network without disconnecting the device operated by the other party, by using the call context information to invoke a replaces functionality in a switch in the enterprise network.

The invention further provides a system for dynamically anchoring selected calls to support call continuity for a subscriber who roams between an enterprise network and another network, comprising: an application client executed by communications devices operated by the subscriber, the application client being programmed to collect call context information respecting calls set up to/from the subscriber and to store the call context information in a data store; and a converged services node in a service provider network, comprising a dynamic call anchoring application programmed to: retrieve the call context information from the data store; to formulate a call setup message containing the call context information to invoke replaces functionality in a switch in the enterprise network when handover of a call to/from the subscriber is required; and, to forward the call setup message to the switch in the enterprise network.

The invention yet further provides an application client for dynamically anchoring selected calls to support call continuity for a subscriber who roams between an enterprise network and another network, comprising: program instructions for collecting call context information when a call is set up to/from the subscriber and program instructions for storing the call context information; and program instructions for launching a call setup message when criteria are satisfied for handover of a call from the enterprise network to the other network or handover of the call from the other network to the enterprise network.

### BRIEF DESCRIPTION OF THE DRAWINGS

Further features and advantages of the present invention will become apparent from the following detailed description, taken in combination with the appended drawings, in which:

FIG. 1 is a schematic diagram of a hosted VoIP network provisioned with a converged services node (CSN) configured to provide dynamic call anchoring in accordance with the invention;

FIG. 2 is a schematic diagram of an IP Multi-Media Subsystem (IMS) network provisioned with a CSN configured to provide dynamic call anchoring in accordance with the invention;

FIG. 3 is a schematic diagram of one embodiment of the CSN provisioned to provide dynamic call anchoring in accordance with the invention;

FIG. 4 is a block diagram of a mobile handset provisioned for dynamic call anchoring in accordance with the invention;

FIG. 5 is a flow diagram providing an overview of tasks performed by the mobile handset shown in FIG. 4 while providing a dynamic call anchoring service in accordance with the invention;

FIG. 6 is a flow diagram providing an overview of tasks performed by a data store configured to assist with dynamic call anchoring in accordance with the invention;

FIG. 7 is a flow diagram providing an overview of tasks performed by the CSN during dynamic call anchoring in accordance with the invention;

FIG. 8 is a message flow diagram schematically illustrating principle messages exchanged between components of the networks shown in FIG. 1 or 2 in providing the dynamic call anchoring service in accordance with the invention;

FIG. 9 is a message flow diagram schematically illustrating principle messages exchanged between components of the networks shown in FIG. 1 or 2 in yet another example of providing the dynamic call anchoring service in accordance with the invention;

FIG. 10 is a message flow diagram schematically illustrating principle messages exchanged between components of the networks shown in FIG. 1 or 2 in providing a dynamic call anchoring service using call park for dynamic call anchoring in accordance with the invention; and

FIG. 11 is a message flow diagram schematically illustrating principle messages exchanged between components of the networks shown in FIG. 1 or 2 in providing a dynamic call anchoring service to a subscriber who uses a single mode cellular handset for roaming outside the enterprise network.

It should be noted that throughout the appended drawings, like features are identified by like reference numerals.

### Detailed Description of the Preferred Embodiment

The invention provides a system and method for dynamic call anchoring to reduce cost and enable the provision of enhanced services to subscribers served by a PBX or an Internet Protocol public branch exchange (IP/PBX) with limited call handling resources and/or limited IP bandwidth. The system includes a mobile handset provisioned with an application client adapted to perform dynamic call anchoring in cooperation with a service provider converged services node (CSN). The mobile handset cooperates with but operates independently of the CSN. In one embodiment, the CSN is embodied as a Session Initiation Protocol (SIP) application server in a VOIP or an IMS network. As used in this document, the word “call” means any communications session, including but not limited to voice and video communications sessions.

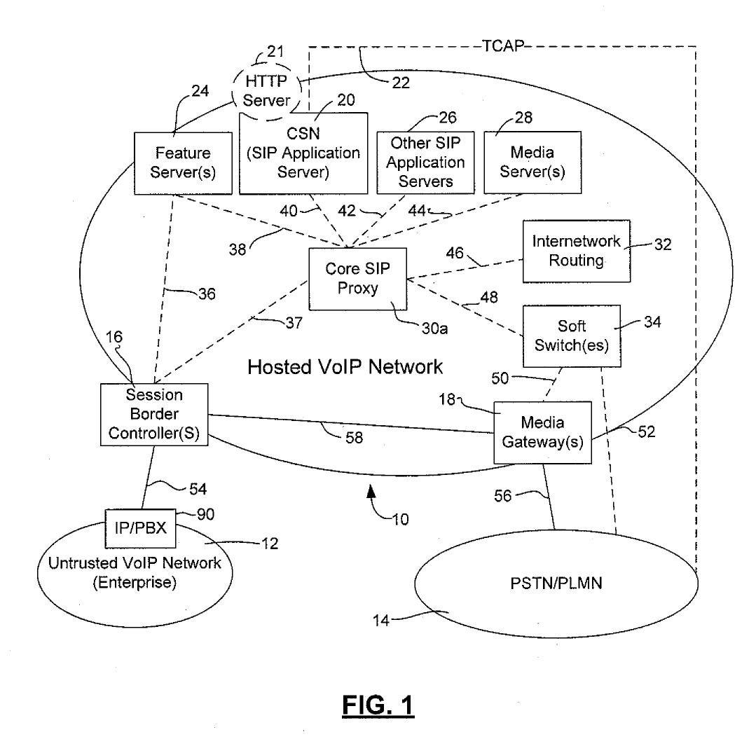

FIG. 1 is a schematic diagram of a hosted VoIP network 10 provisioned with a CSN configured to perform dynamic call anchoring in accordance with the invention. As is well understood by those skilled in the art, hosted VoIP networks are connected to untrusted VoIP networks 12 that serve Enterprise environments commonly provisioned with switching equipment that supports packet communications, such as an Internet Protocol Public Branch Exchange (IP/PBX) 90. The hosted VoIP network 10 is also connected to the PSTN/PLMN 14 to permit the offering of transparent communications services originated or terminated in any one of networks 12 and 14. The untrusted VoIP networks 12 are connected to the hosted VoIP network 10 by session border controllers 16, well known in the art. The PSTN/PLMN network 14 is connected to the hosted VoIP network 10 by Media Gateways 18 and soft switches 34.

The hosted VoIP network 10 is provisioned with the CSN 20, which acts as a SIP Application Server to provide inter-working functions for specific services between the PSTN/PLMN 14 and the VoIP networks 10, 12. The hosted VoIP network 10 further includes one or more feature servers 24 which receive incoming communications session requests from the session border controller(s) 16 via communications link(s) 36 in a manner well known in the art. The hosted VoIP network 10 further includes other SIP application servers 26 and media servers 28, both of which are known in the art. Each of the servers are connected to a core SIP Proxy 30a which has global knowledge of the hosted VoIP network 10 and controls intra-network routing. An inter-network routing server 32 provides routing control when calls must be routed to other connected networks 12, 14. Soft switches 34 perform soft switching services within the hosted VoIP network 10. The soft switches 34 are connected by signaling links 52 to PSTN/PLMN network 14 and are IP connected as indicated at 50 to the Media Gateways 18. Communication channel 58 connects the session border controllers 16 and the Media Gateways 18. Trunks 56 connect the Media Gateways 18 to the PSTN/PLMN 14. IP interfaces 38, 40, 42, 44, 46 and 48 respectively connect the feature servers 24, CSN 20, SIP application servers 26, media servers 28, inter-network routing server 32 and soft switches 34 to the core SIP Proxy 30a in a manner well known in the art. IP interfaces 36 and 37 connect the session border controllers 16 to the feature servers 24 and the core SIP Proxy 30a, likewise in a manner known in the art.

It should also be noted that the CSN 20 may be connected to the signaling network of the PSTN/PLMN 14 by any version or variant of Transaction Capabilities Application Part (TCAP) signaling links 22. This permits the CSN 20 to coordinate and control calls originating in the PSTN/PLMN 14, the hosted VoIP network 10, or other untrusted VoIP networks 12, provided that signaling routes provisioned in the respective networks are configured to route signaling messages to the CSN 20 as explained in detail in applicant's co-pending United States Patent Application Publication No. 20060142010 entitled Method, System and Apparatus for Call Path Reconfiguration filed Dec. 27, 2004, the specification of which is incorporated herein by reference.

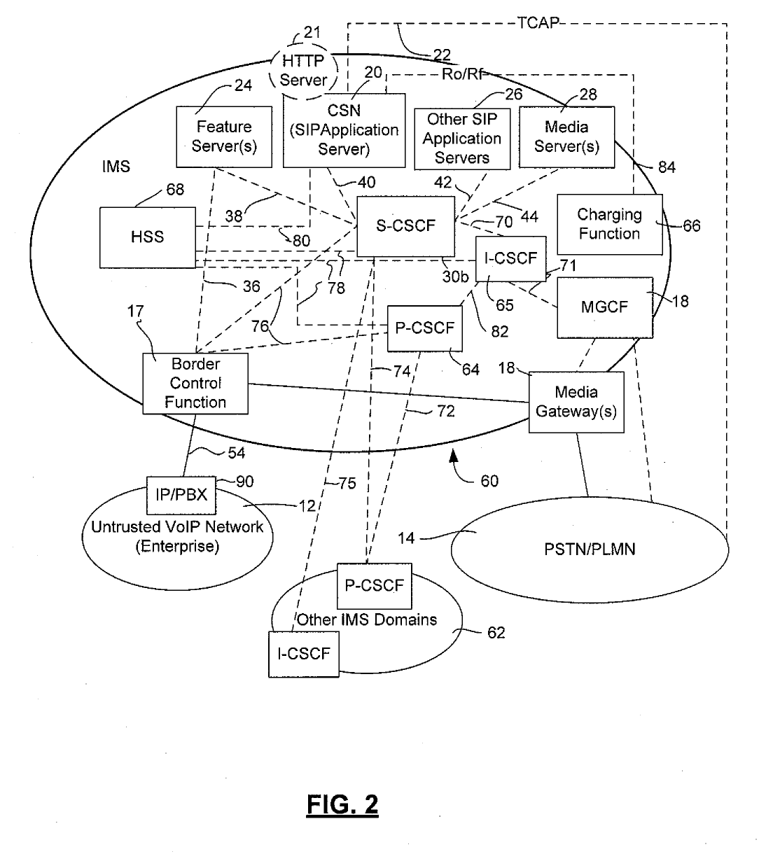

FIG. 2 is a schematic diagram of an IMS network 60 provisioned with the CSN 20. The IMS network 60 is connected by links 54 to: other untrusted VoIP networks 12 by border control functions 17; the PSTN/PLMN 14 by Media Gateways 18; and, other IMS domains 62 by signaling links 72, 74 and 75. In addition to the components described above with reference to FIG. 2, the IMS 60 includes a session charging function 66 connected to the CSN 20 by signaling link 84 and a home subscriber server (HSS) 68 connected to the CSN 20 by signaling link 80 and to a proxy/service/interrogating call session control function (P-CSCF) 64 by a signaling link 78.

A Serving Call Session Control Function (S-CSCF) 30b functions in a way similar to the core SIP Proxy 30 described with reference to FIG. 1, and is connected to the other network components in the same way. The S-CSCF 30b and the P-CSCF 64 are connected to the border control function(s) 17 by signaling links 76. The S-CSCF 30b is also connected to an Interrogating Call Session Control Function (I-CSCF) 65 by a signaling link 70, which is in turn connected to the Media Gateway control function (MGCF) 18 by a signaling link 71 and to the P-CSCF 64 by a signaling link 82. The S-CSCF 30b is connected to the other IMS domain 62 by a signaling link 74. The P-CSCF 64 is connected to the other IMS domains by a signaling link 72. All components, interconnections and operations of all elements of the IMS 60 are well known in the art, with the exception of the CSN 20.

As described above with reference to FIG. 1, the CSN 20 may be connected to the signaling network of the PSTN/PLMN 14 by any version or variant of Transaction Capabilities Application Part (TCAP) signaling links 22. This permits the CSN 20 to coordinate and control calls originating in the PSTN/PLMN 14, the IMS 60, other IMS domain 62 or untrusted VoIP networks 12, provided that signaling routes provisioned in the respective networks are configured to route signaling messages to the CSN 20.

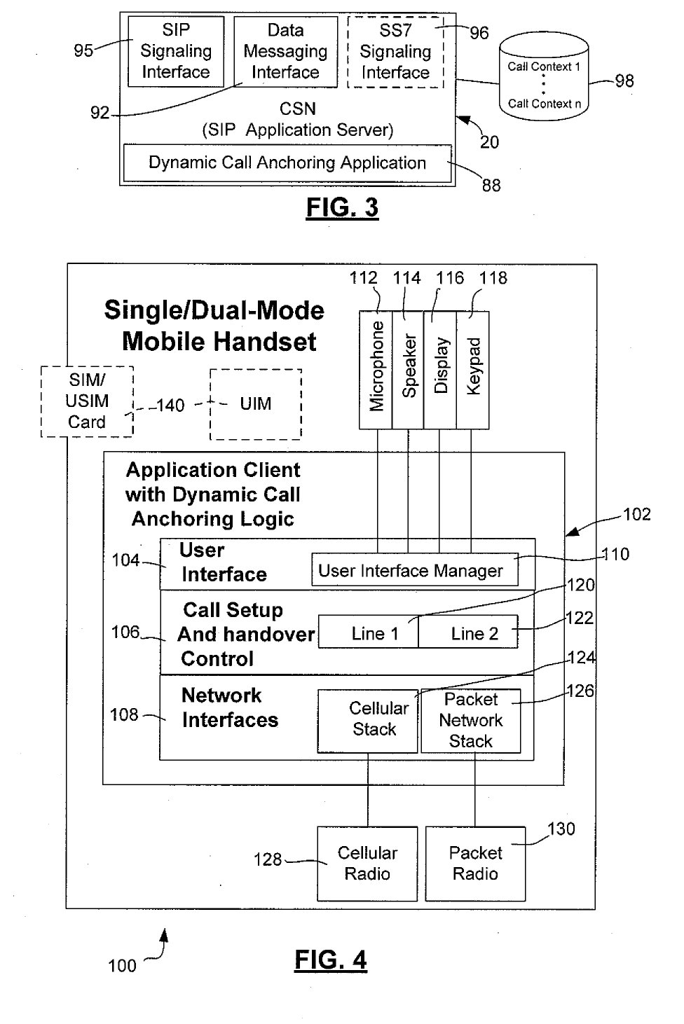

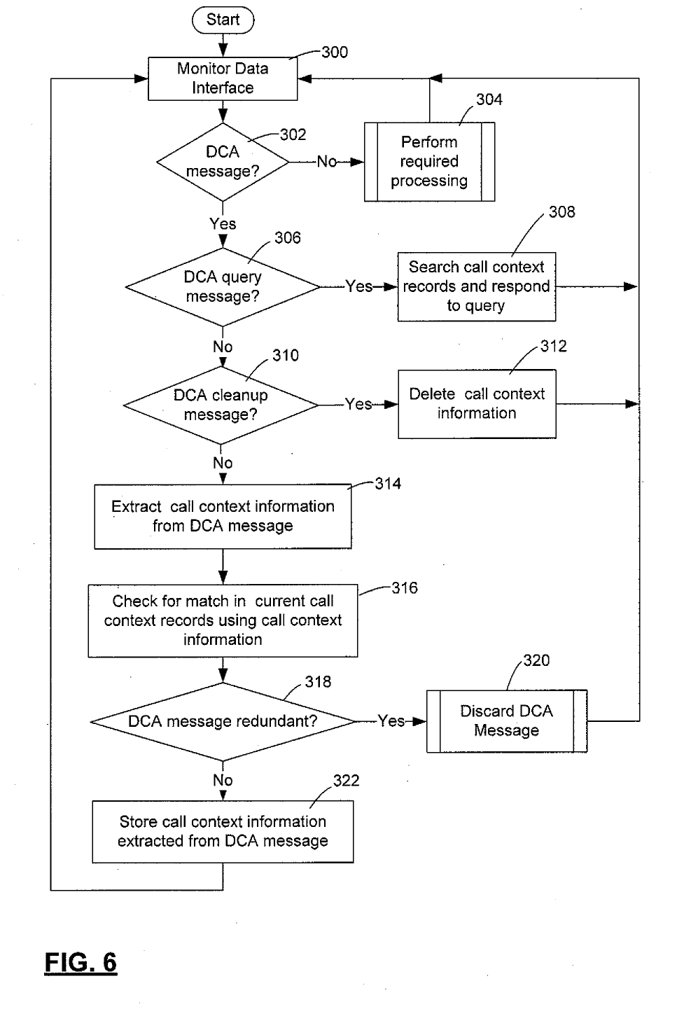

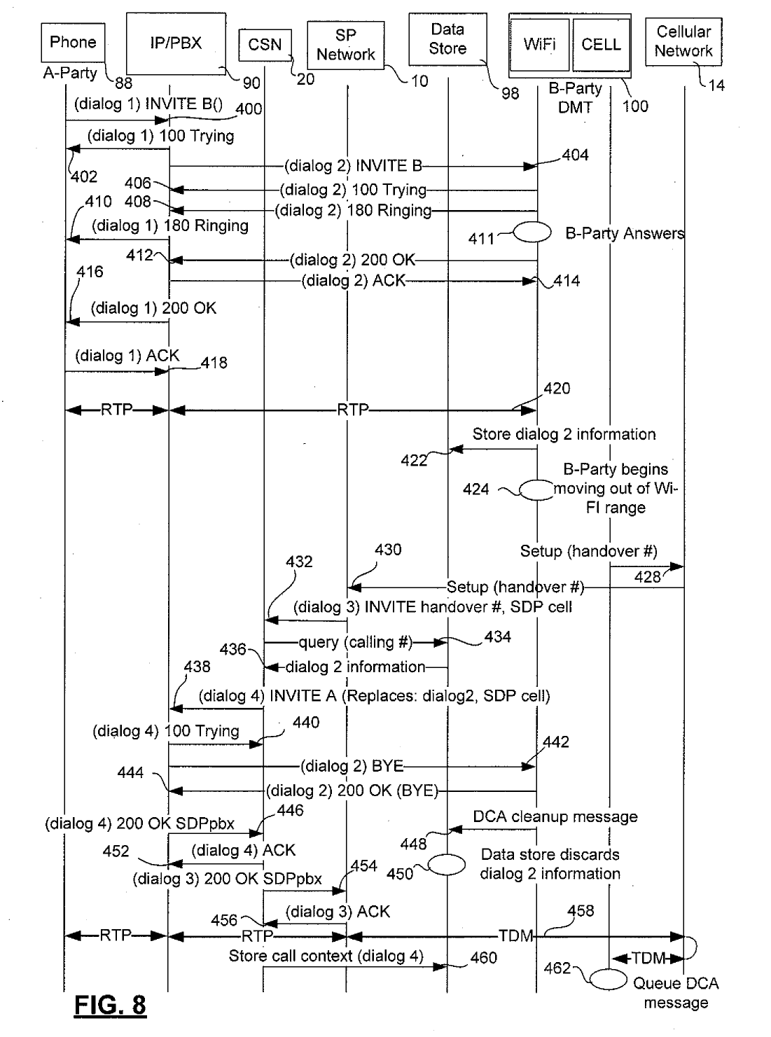

FIG. 3 is a schematic diagram of one embodiment of the CSN provisioned to provide dynamic call anchoring in accordance with the invention. As explained above, in this embodiment the CSN 20 is a SIP Application Server. The CSN 20 is provisioned with a dynamic call anchoring (DCA) application 88 programmed to function as described below with reference to FIGS. 8-11. The CSN 20 is also provisioned with a data messaging interface 92, a SIP signaling interface 95, and optionally a SS7 signaling interface 96. The CSN 20 is also logically connected to or provisioned with a data store 98 that is populated with call context records, as will be explained below in more detail with reference to FIGS. 6 and 8-11. In one embodiment the data store 98 is a Hypertext Transfer Protocol (http) server.

FIG. 4 is a block diagram of a single/dual-mode mobile handset 100, hereinafter referred to simply as the mobile handset 100, provisioned with a mobile handset application client 102 that is programmed with dynamic call anchoring application logic to perform client functions for dynamic call anchoring in accordance with the invention. The application client 102 operates cooperatively with but independently of the CSN 20 to enable dynamic call anchoring.

The application client 102 includes a user interface 104 provisioned with a user interface manager 110. The user interface manager 110 controls a microphone 112, a speaker 114, and a visual display 116 and accepts inputs from a keypad 118 in a manner well known in the art. The application client 102 further optionally includes a call setup and handover control 106, which is provisioned with a first line 120 (Line 1) and a second line 122 (Line 2). Line 1 (120) and Line 2 (122) are used to enable subscriber features such as “call waiting”, “3-way conference” and “call hold”, all of which are known in the art.

Network interfaces 108 support a cellular stack 124, and a packet network stack 126. The cellular stack 124 includes a set of layered protocols that are used in existing cellular networks. These protocols are used to send information to and receive information from an MSC via a base station using a cellular radio 128. Similarly, the packet network stack 126 includes a set of layered protocols for sending and receiving information via a packet network using a packet radio 130. The mobile handset 100 may be provisioned with a Subscriber Identity Module (SIM) 140 for GSM 2G/2.5G devices; a Universal Subscriber Identity Module (USIM) 140 for GSM 3G devices; or an embedded User Identity Module (UIM) 140 for 2G/2.5G CDMA devices.

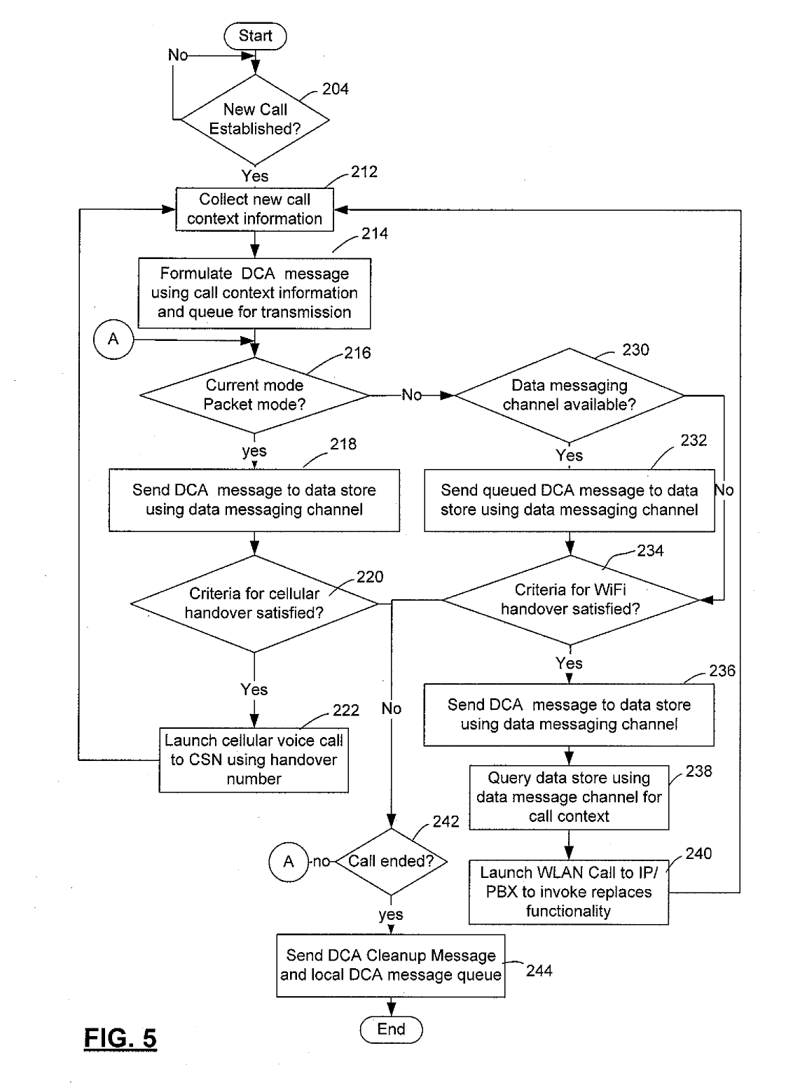

FIG. 5 is a flow diagram providing an overview of an exemplary way of programming the application client 102 of the mobile handset 100 shown in FIG. 3, to provide the dynamic call anchoring service in accordance with one embodiment of the invention. It should be understood that different logic could be used to program the application client 102 to effect dynamic call anchoring in accordance with the invention. In this embodiment, the application client 102 of the mobile handset 100 is programmed to monitor (204) the network interfaces 108 (FIG. 4) to determine when a new call is established. When a new call has been established, the application client 102 collects call context information (212). The call context information is extracted from call setup data passed to the mobile handset 100. The call context information collected depends on the type of call established and may be, for example, calling and called Session Initiation Protocol (SIP) addresses, or calling and called PLMN numbers, or any combination of the two. The application client 102 then formulates a dynamic call anchoring (DCA) message (214) using the call context information collected at 212, and queues the DCA message for transmission to the data store 98 (see FIG. 3).

As understood by those skilled in the art, in certain cellular modes a data channel is not available to transmit data messages while a call is in progress. The application client 102 therefore checks current call connection mode (216) to determine whether the current call connection mode is packet mode. If so, the application client 102 transmits the queued DCA message to the data store 98 (218) using an available data messaging channel. The application client 102 then determines (220) whether the criteria for handover to the public cellular network have been satisfied. As understood by those skilled in the art, those criteria may include: policy rules respecting packet/cellular use; and, availability and/or relative strength of the packet/cellular signals. If it is determined that the criteria for cellular handover have been satisfied, a call is launched (222) to the CSN 20 using a preprogrammed handover number, as will be explained below in detail with reference to FIG. 8. Otherwise, it is determined (242) whether the call has ended. If the call has not ended, the process returns to 216. If the call has ended, a DCA cleanup message is formulated to instruct the data store 98 to delete the stored call context information, as will be explained in more detail with reference to FIG. 6, and all messages in the message queue including the DCA cleanup message are transmitted (244) to the data store 98 using an available data channel.

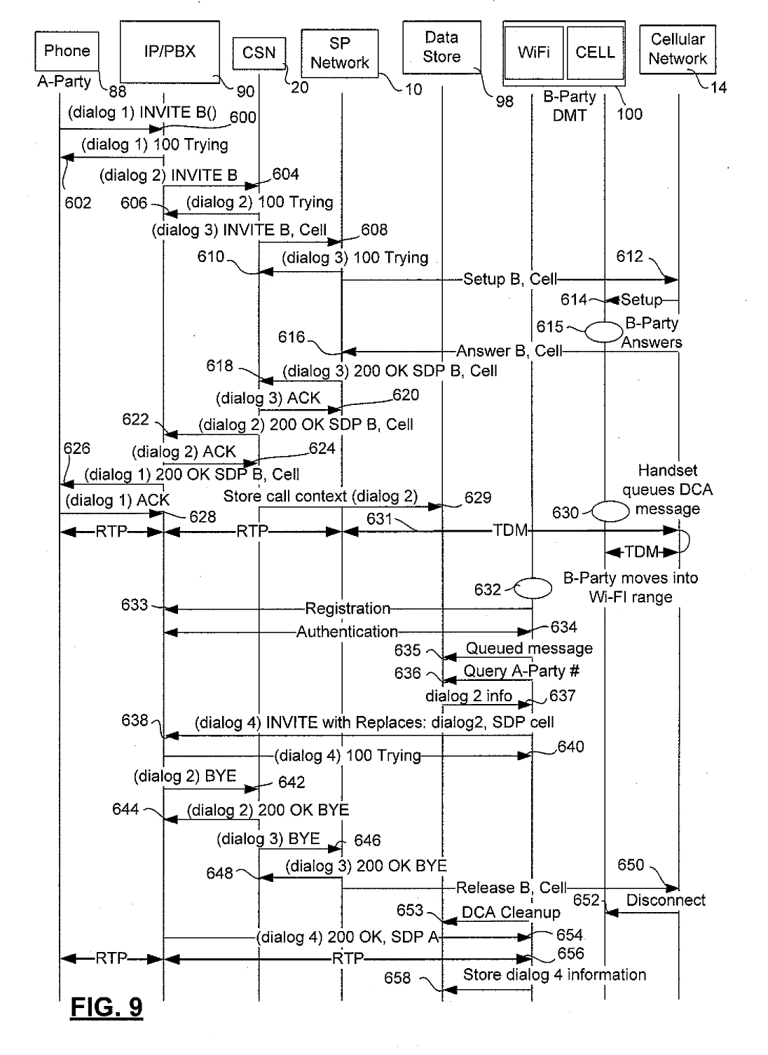

If it is determined at 216 that the current call mode is cellular mode, the application client determines (230) whether a data channel is available. If so, the queued DCA message is transmitted (232) using the available data channel. If not, the queued DCA message remains queued. The application client 102 then determines (234) whether the criteria for handover to the enterprise network (WiFi (packet mode)) have been satisfied. As explained above, the criterion/criteria may include any one or more of: policy rules respecting packet/cellular use; network connectivity; and/or relative signal strength of the respective packet and cellular network signals. If the criterion or criteria for WiFi handover has/have not been satisfied, the application client determines (242) whether the call has ended and if so transmits any queued messages including the DCA cleanup message, as explained above. If it is determined at 234 that the criteria for WiFi handover have been satisfied, the application client 102 switches to Wi-Fi mode and transmits (236) the queued DCA message to the data stored 98 using an available data messaging channel. The application client 102 then queries (238) the data store 98 for call context information using the available data messaging channel. When a response is received from the data store 98, the call context information is used to formulate a SIP INVITE message (240) to launch a WLAN call to the IP/PBX that serves the mobile handset 100. The SIP INVITE message contains a Replaces header or other convention for invoking replaces functionality of the IP/PBX, as will be explained below in more detail with reference to FIGS. 8 and 9. The application client 102 then collects new call context information (212) and the process described above repeats.

FIG. 6 is a flow diagram providing one exemplary overview of tasks performed by the data store 98 when dynamic call anchoring in accordance with the invention is performed. The data store 98 continually monitors its data channel interface (300). Each time a message is received on the data channel interface, the message is inspected to determine whether it is a dynamic call anchoring message (302). If the message is not a dynamic call anchoring message, any processing required by the message is performed (304) and the data store 98 returns to monitoring its data channel interface (300). If the message is a dynamic call anchoring message, it is determined whether the message is a DCA query message (306). A DCA query message may be sent by either the CSN 20 or the application client 102 of the mobile handset 100, as will be explained below with reference to FIGS. 8-11. If a DCA query message is received information is extracted from the DCA query message and used to search the call context records in the data store 98 (308). A response, which includes call context information if a match is found, is then sent to the DCA query message. If it is determined at 306 that the DCA message is not a DCA query message, it is determined (310) whether the DCA message is a DCA cleanup message. As explained above, DCA cleanup messages are sent by the application client 102 when a call is ended. If the message is a DCA cleanup message, call context information referenced by the DCA cleanup message is deleted (312) from the call context data store, and the data store 98 returns to monitoring its data channel interface (300).

If the received message is not a DCA cleanup message, call context information is extracted from the DCA message (314). The call context information is used to check for a match in current call context records (316) to determine whether the DCA message is redundant (318). If so, the DCA message is discarded (320). If not, the call context information is stored (322) for potential use in responding to queries received from the CSN 20 or the mobile handset 100, as explained above. In either case, the data store returns to monitoring its dated interface (300).

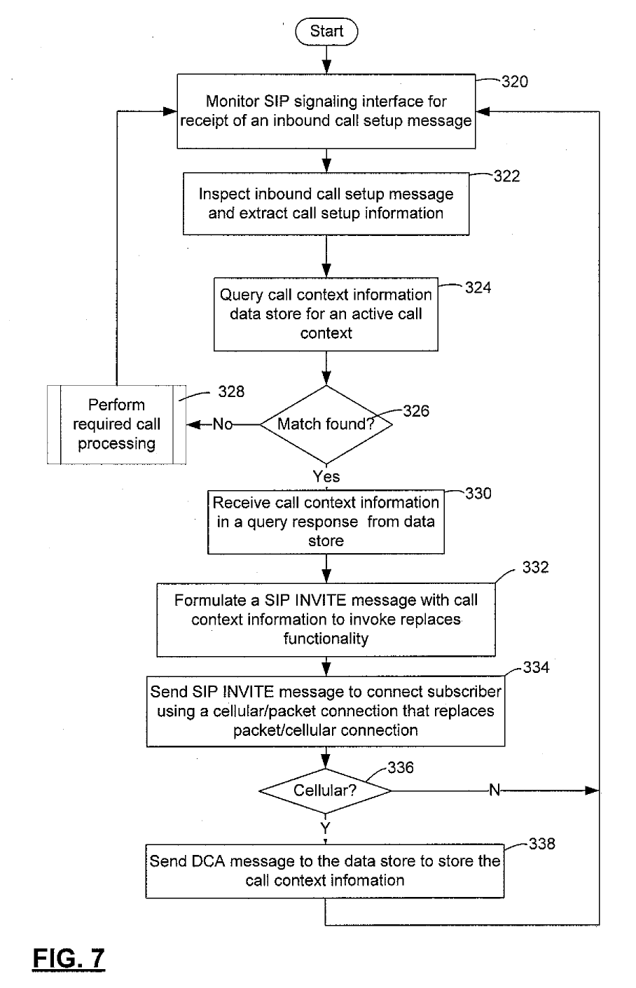

FIG. 7 is a flow diagram providing an exemplary overview of tasks performed by one embodiment of the DCA application 88 executed by the CSN 20 during dynamic call anchoring. The CSN 20 monitors its SIP signaling interface 95 for receipt of an inbound (INVITE) call setup message (320). Each time an inbound call setup message is received, the CSN 20 inspects the call setup message and extracts call setup information (322). The CSN 20 then queries the data store 98 for a matching call context record (324). The CSN 20 waits for a response from the data store 98 before continuing with call processing. If it is determined (326) that no matching call context information was found, the CSN 20 performs any call processing (328) required by the call setup message and returns to monitoring the SIP signal interface (320).

If a match is found (326), the CSN 20 receives the matching call context information in a query response from the data store 98 (330). The CSN then formulates a SIP INVITE message using the call context information (332), and sends the SIP INVITE message to connect the subscriber using a cellular/packet connection that replaces a packet/cellular connection currently being used by the subscriber (334), as will be explained below in more detail with reference to FIGS. 8-11. The CSN 20 then determines (336) whether the SIP INVITE message was used to connect the subscriber using a cellular or a packet connection If the connection was cellular, the subscriber handset may not be able to send a DCA message directly to the data store 98 because a data channel may not be available. Consequently, the CSN 20 serves as a proxy to the mobile handset 100 and formulates a DCA message containing the call context information associated with dialog 4 and sends the DCA message to the data store 98 (338) before returning to monitoring SIP signaling interface 95 (320). If the connection was a packet connection, the CSN 20 simply returns to monitoring the SIP signaling interface 95 (320), because the mobile handset can send the DCA message directly to the data store 98.

FIG. 8 is a message flow diagram schematically illustrating principle messages exchanged between components of the networks shown in FIG. 1 or 2 in an example of providing dynamic call anchoring in accordance with one embodiment of the invention. In this example, an A-Party using a telephone 88 dials a B-Party's number (400). Both A-party and B-party are enterprise employees served by an IP/PBX 90 in the enterprise packet network. A-Party uses IP telephone 88 to dial a number associated with the mobile handset 100 used by B-Party. When A-Party dials the number of B-Party, the IP telephone 88 generates a SIP INVITE message, which is sent (400) to the IP/PBX 90 using SIP signaling protocols well known in the art. On receipt of the INVITE message, the IP/PBX 90 returns a SIP 100 Trying message (402). The IP/PBX 90 then formulates a SIP INVITE message which is forwarded through the wireless local area network (WLAN) of the enterprise to the mobile handset 100. The mobile handset 100 receives the SIP INVITE message through its packet radio interface 130 (404), and responds with a SIP 100 Trying message (406), in accordance with the SIP protocol. The mobile handset 100 then returns a SIP 180 Ringing message (408). The IP/PBX 90 in turn formulates a SIP 180 Ringing message which is forwarded to the IP telephone 88 (410).

B-Party responds to ringing of the mobile handset 100 by answering the call (411). This prompts the mobile handset 100 to return a SIP 200 OK message (412). The IP/PBX 90 responds with a SIP ACK message (414) and sends (416) a SIP 200 OK message to the IP telephone 88, which in turn responds with a SIP ACK message (418). A packet voice connection (420) is established between the IP telephone 88 and the mobile handset 100. In this example, Real Time Protocol (RTP) is used for the packet voice connection. After the packet voice connection is set up, the mobile handset 100 extracts call context information associated with the call and forwards it (422) to the data store 98, as explained above with reference to FIG. 6.

At some time during the conversation between A-Party and B-Party, B-Party begins leaving the enterprise and moving out of Wi-Fi range (424) of the enterprise packet network. The mobile handset 100 determines that the criteria for public cellular network handover have been satisfied, as explained above with reference to FIG. 5, and the application client 102 launches (428) a cellular call through the cellular radio 128 to a handover number associated with the CSN 20. A Setup message for the cellular call is received by the cellular network 14, which formulates a Setup message that is forwarded (430) through the cellular network to the service provider network 10. The SS7 signaling required for the cellular call setup is well understood by those skilled in the art and not illustrated in detail. On receipt of the Setup message, the service provider network 10 formulates a SIP INVITE message containing the handover number and a service description protocol (SDP) for the cellular radio of the mobile handset 100, and forwards the SIP INVITE message (432) to the CSN 20. The handover number is associated with the dynamic call anchoring service. Consequently, the CSN 20 uses the other party number to query (434) the data store 98 in order to retrieve call context information associated with the packet voice connection in which the mobile handset 100 is still engaged.

On receipt to the query message sent by the CSN 20, the data store 98 searches the call context records, as explained above with reference to FIG. 6, and returns (436) the call context information associated with the packet voice connection in session between A-Party and B-Party. On receipt to the query response, the CSN 20 formulates a SIP INVITE message containing the call context information and the SDP of the cellular radio 130, and forwards the SIP INVITE message through the service provider network to the IP/PBX 90 (438). The SIP INVITE message is structured in a standardized (RFC 3891) or a proprietary way to invoke a “replaces functionality” in the IP/PBX 90. As used in this document, “replaces functionality” refers to an operation in which a third call leg is sent to a call control entity (the IP/PBX 90, for example) that is supporting first and second call legs in a connected state. The third call leg is sent with sufficient reference information about one of the call legs in the connected state to permit that call leg to be replaced by the third call leg. Upon receipt of the third call leg and the reference information, the call control entity joins the third call leg with a specified one of the first and second call legs by synchronizing media parameters between the specified call leg and the third call leg. The call control entity then releases the replaced call leg.

On receipt of the SIP INVITE message, the IP/PBX 90 responds with a SIP 100 trying message (440). After analyzing the SIP INVITE message, the IP/PBX 90 releases the packet voice connection to the packet radio 128 of the mobile handset 100 by sending a SIP BYE (442) to the mobile handset 100. The mobile handset 100 responds with a SIP 200 OK message (444) and the packet voice connection is torn down.

The IP/PBX 90 may refresh the call leg that connects the IP PBX 90 and A-party 88, the IP/PBX 90 then formulates a SIP 200 OK message containing the SDP of the IP/PBX 90 and forwards the message (446) to the CSN 20. Meanwhile, the mobile handset 100 formulates a DCA cleanup message which it sends (448) to the data store 98. The data store 98 responds by discarding the call context information associated with the torn down packet voice connection between A-Party and B-Party. Simultaneously, the CSN 20 responds to the IP/PBX 90 with a SIP ACK message (452), and sends a SIP 200 OK message containing the SDP of the IP/PBX 92 the service provider network 10 (454). The service provider network 10 responds with a SIP ACK message (456) and a voice connection is reestablished between A-Party and B-Party (458). As explained above with reference to FIG. 7, since the connection established to the subscriber is a cellular connection, the CSN 20 serves as a proxy to the mobile handset 100 and formulates a DCA message containing the call context information and sends it (460) to the data store 98. Meanwhile, the mobile handset 100 queues a DCA message containing the call context information (462), as explained above with reference to FIGS. 5 and 6. As will be understood by those skilled in the art, the entire transition from the packet voice connection to the packet/cellular voice connection and the dynamic anchoring of the call in the CSN 20 was automatic and transparent to both A-Party and B-Party.

FIG. 9 is a message flow diagram schematically illustrating principle messages exchanged between components of the networks shown in FIG. 1 or 2 in yet another example of providing the dynamic call anchoring service in accordance with the invention. In this example, A-Party is connected to the enterprise WLAN and launches a packet voice call to the single number associated with the mobile handset 100. The IP telephone 88 formulates a SIP INVITE message containing the B-Party number and forwards the message to the IP/PBX 90 (600). The IP/PBX 90 returns a SIP 100 Trying message (602). The IP/PBX 90 then formulates a SIP INVITE message containing the B-Party number and forwards the message (604) to the CSN 20, which in this example is the cellular number used when there is no WLAN presence for B-Party. The CSN 20 returns a SIP 100 Trying message (606), and sends a SIP INVITE message with the B-Party number and a cell indication (608) to the service provider network 10. The service provider network 10 returns a SIP 100 Trying message (610).

The service provider network 10 then formulates a SS7 signaling message to set up a call to the cellular radio of the mobile handset 100 and forwards the message (612) to the cellular network 14. The cellular network 14 in turn formulates a Setup message that is sent to the cellular radio of the mobile handset 100 (614) and B-Party answers the call (615). This causes the cellular network 14 to return an Answer message (616) to the SP network 10. As explained above, the SS7 signaling used to establish the cellular call is well known and is not illustrated in detail. On receipt of an Answer message (not shown), the service provider network 10 formulates a SIP 200 OK message containing the SDP of the cellular radio of the mobile handset 100 and sends the message (618) to the CSN 20. The CSN 20 returns a SIP ACK message (620) and sends a SIP 200 OK message containing the SDP of the cellular radio to the IP/PBX 90 (622). The IP/PBX 90 responds with a SIP ACK message (624) and sends a SIP 200 OK message containing the SDP corresponding to the mobile handsets cellular radio to the IP telephone 88 (626). The IP telephone 88 returns a SIP ACK message (628). Since the connection to the subscriber is a cellular connection, the CSN 20 serves as a proxy to the mobile handset 100 and formulates a DCA message containing the call context information associated with dialog 2 and sends (629) the DCA message to the data store 98. Meanwhile, the mobile handset 100 queues a DCA message containing the call context information (630). A voice connection (631) is thus established between A-Party and B-Party. The voice connection (631) is a packet connection between the IP telephone 88 and the service provider network 10 and a TDM connection between the service provider network 10 and the mobile handset 100.

During the conversation between A-Party and B-Party, B-Party moves (632) into Wi-Fi a range of the enterprise WLAN. The mobile handset 100 detects the WLAN signal and sends a registration message (633) to the IP/PBX 90. An authentication process ensues (634) and the mobile handset 100 is subsequently registered (not shown) with the IP/PBX 90, On registration, the IP data channel becomes available and the mobile handset 100 sends (635) queued DCA message(s) to the data store 98. Policy rules stored on the mobile handset 100 dictate in this example that the enterprise WLAN be used when it is available. Consequently, the application client 102 formulates a query message containing the A-Party number, and sends the query message (636) to the data store 98. The data store 98 processes the query message and returns (637) the dialog 2 information. The application client uses the dialog 2 information to formulate a SIP INVITE message (638) to invoke the replaces functionality, as explained above. The SIP INVITE message contains the call context information collected by the mobile device 100 at 630. In response to the SIP INVITE message, the IP/PBX 90 returns a SIP 100 Trying message (640).

The SIP INVITE message received at 638 instructs the IP/PBX 90 to release the cellular connection to the mobile handset 100. The IP/PBX 90 therefore formulates a SIP BYE message which it forwards (642) to the CSN 20. The CSN 20 responds with a SIP 200 OK BYE message (644), and sends a BYE message (646) to the service provider network 10. The service provider network 10 returns a SIP 200 OK BYE message (648), and sends a Release message (650) to the cellular network 14. The cellular network 14 sends a Disconnect message to the cellular radio of the mobile handset 100 (652), and the cellular voice connection between the service provider network 10 and the mobile handset 100 is torn down. The mobile handset 100 therefore sends a DCA cleanup message to the data store 98 containing dialog 2 information, and the data store deletes (not shown) any stored records associated with the torn down call. Details of the SS7 signaling for tearing down the TDM connection are not shown. Meanwhile, the IP PBX 90 formulates and sends a SIP 200 OK message containing the SDP of the A-Party telephone 88 to the packet radio of the mobile handset 100 (654). A packet voice connection (656) is thereby establish between A-Party and B-Party. In accordance with policy, the mobile handset 100 sends a DCA message (658) to the data store 98 containing the call context information that is stored in the call context records, as explained above.

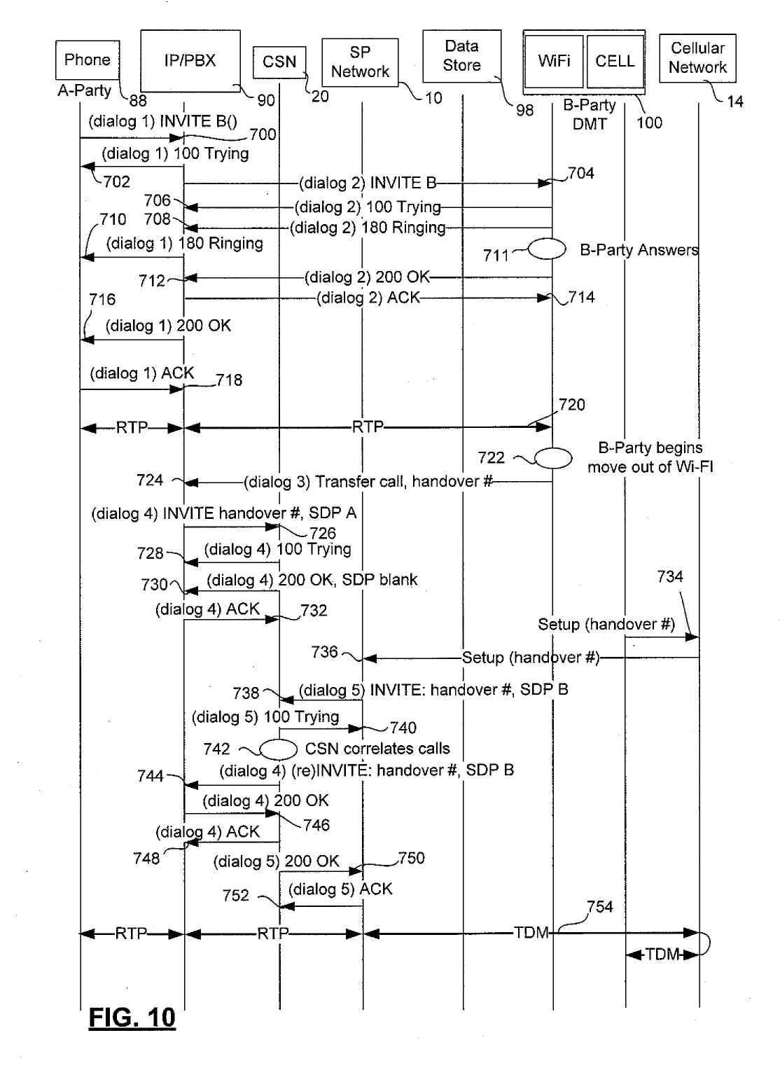

FIG. 10 is a message flow diagram schematically illustrating principle messages exchanged between components of the networks shown in FIG. 1 or 2 in providing a dynamic call anchoring service using call park for dynamic call anchoring in accordance with another embodiment of the invention. In this example, A-Party dials the single number associated with the mobile handset 100 to establish a voice connection with B-Party. IP Telephone 88 therefore formulates a SIP INVITE message containing the single number associated with the mobile handset 100 and forwards it (700) to the IP/PBX 90. On receipt of the SIP INVITE message, the IP/PBX 90 returns a SIP 100 Trying message (702), and formulates a SIP INVITE message containing the single number of the mobile handset 100, which it forwards to the mobile handset 100 (704) because B-Party is in the enterprise and the mobile handset 100 is connected to the enterprise WLAN. The mobile handset 100 responds with a SIP 100 Trying message (706) followed by a SIP 180 Ringing message (708). The IP/PBX 90 forwards a SIP 180 Ringing message to the IP telephone 88 (710). When B-Party answers the call (711) the mobile handset 100 returns a SIP 200 OK message to the IP/PBX 90 (712) which responds with a SIP ACK message (714). The IP/PBX 90 then sends a SIP 200 OK message to the IP telephone 88 (716) which responds with a SIP ACK message (718), and a packet voice connection (720) is established between A-Party and B-Party.

While still engaged in the conversation with A-Party, B-Party begins to move out of the enterprise Wi-Fi range (722). When it is determined that the criteria for cellular handover have been satisfied (see FIG. 5), the mobile handset 100 forwards a data message to the IP/PBX 90 instructing the IP/PBX 90 to transfer the call to a handover number associated with the CSN 20 (724). The IP/PBX 90 responds by formulating a SIP INVITE message containing the handover number and a SDP of A-Party's telephone 88 to the CSN 20 (726). The CSN 20 responds with a SIP 100 Trying message (728) followed by a SIP 200 OK message containing a blank SOP (730). Alternatively, the CSN 20 may provide the SDP of a media resource like an announcement in the 200 OK message (730). The IP PBX 90 responds with a SIP ACK message (732). Meanwhile, the client application 102 launches a cellular call to the handover number (734) which prompts the cellular network 14 to send a Setup message containing the handover number (736) to the service provider network 10. The service provider network 10 responds by formulating a SIP INVITE message containing the handover number and a SDP of the cellular radio 128 of the mobile handset 100, which it sends to the CSN 20 (738). The CSN 20 responds with a SIP 100 Trying message (740). The CSN 20 then correlates the two calls using the handover number (742) and formulates a SIP (re)INVITE message containing the handover number and the SDP of the mobile device 100, which it sends to the IP/PBX 90 (744). The IP PBX 90 responds with a SIP 200 OK message (746), and the CSN 20 responds with a SIP ACK message (748). The CSN 20 then sends a SIP 200 OK message (750) to the service provider network 10, which responds with a SIP ACK message (752) and a voice connection (754) is re-established between A-Party and B-Party after a brief voice interruption.

It should also be understood that alternatively PBX park and pickup functionality can be used to complete a transfer of a call between the WiFi and cellular modes of the mobile handset 100. In that case, the mobile handset 100 transfers the call to a pickup number in message sent at 724, and subsequently the CSN 20 forwards a SIP INVITE message to the pickup number in the message sent at 744.

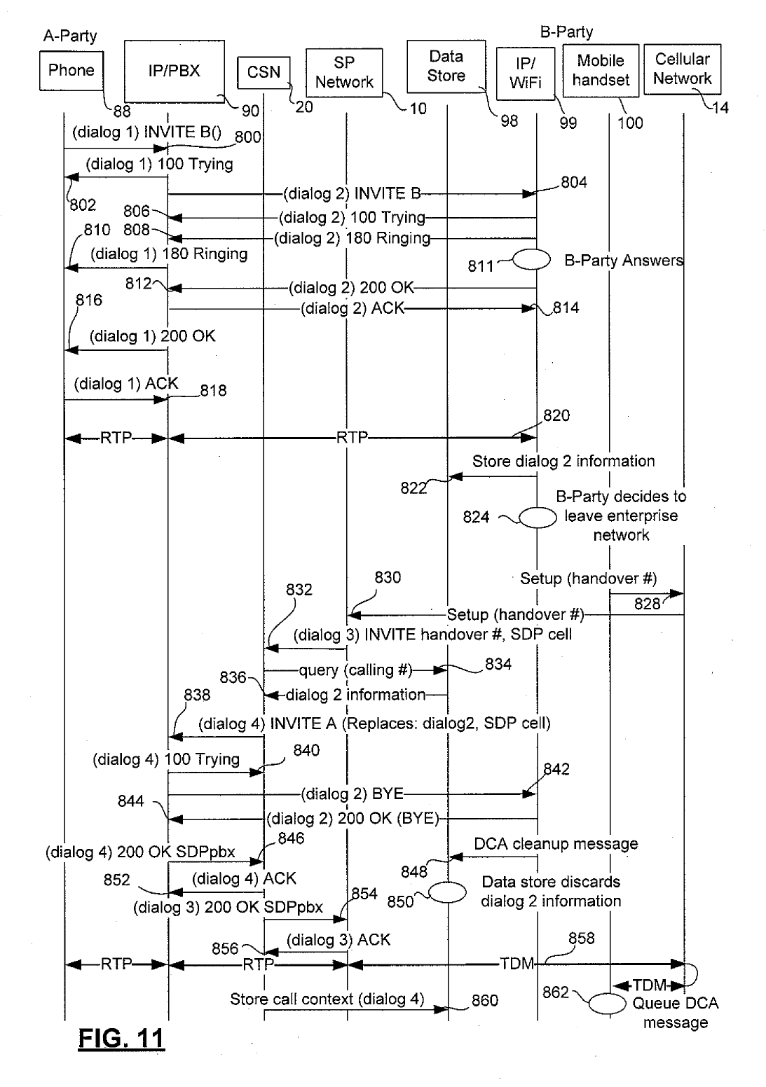

Although the examples presented in FIGS. 8-10 have described dynamic call anchoring service in accordance with the invention with reference to mobile handsets 100 that are dual-mode mobile devices, it must be understood that the invention is not limited to such devices and can easily be provisioned for subscribers who employ a single-mode cellular telephone for roaming outside the enterprise and a separate IP or Wi-Fi voice device for use within the enterprise network. In the example shown in FIG. 11, the subscriber employs a separate IP/WiFi voice device 99 in the enterprise packet network and a single-mode cellular handset 100 for roaming outside the enterprise packet network. Each device is provisioned with an application client 102 provisioned with program instructions appropriate to the functionality of the device.

FIG. 11 is a message flow diagram schematically illustrating principle messages exchanged between components of the networks shown in FIG. 1 or 2 in an example of providing dynamic call anchoring in accordance with this embodiment of the invention to a subscriber who uses separate devices in the respective enterprise and public networks. In this example, an A-Party using a telephone 88 dials a B-Party's number (800). Both A-party and B-party are enterprise employees served by the IP/PBX 90. A-Party uses IP telephone 88 to dial a number associated with the IP/WiFi device 99 used by B-Party within the enterprise network. When A-Party dials the number of B-Party, the IP telephone 88 generates a SIP INVITE message, which is sent (800) to the IP/PBX 90 using SIP signaling protocols well known in the art. On receipt of the SIP INVITE message, the IP/PBX 90 returns a SIP 100 Trying message (802). The IP/PBX 90 then formulates a SIP INVITE message which is forwarded through the WLAN of the enterprise packet network to the IP/WiFi device 99. The IP/WiFi device 99 receives the SIP INVITE message (804), and responds with a SIP 100 Trying message (806), in accordance with the SIP protocol. The IP/WiFi device 99 then returns a SIP 180 Ringing message (808). The IP/PBX 90 in turn formulates a SIP 180 Ringing message which is forwarded to the IP telephone 88 (810).

B-Party responds to ringing of the IP/WiFi device 99 by answering the call (811). This prompts the IP/WiFi device 99 to return a SIP 200 OK message (812). The IP/PBX 90 responds with a SIP ACK message (814) and sends (816) a SIP 200 OK message to the IP telephone 88, which in turn responds with a SIP ACK message (818). A packet voice connection (820) is established between the IP telephone 88 and the IP/WiFi device 99. In this example, Real Time Protocol (RTP) is used for the packet voice connection. After the packet voice connection is set up, the IP/WiFi device 99 extracts call context information associated with the call and forwards it (822) to the data store 98, as explained above with reference to FIG. 6.

At some time during the conversation between A-Party and B-Party, B-Party decides to leave the enterprise (824). B-Party therefore uses the mobile handset 100 to launch a cellular call through the cellular radio 128 to a handover number associated with the CSN 20. A Setup message (828) for the cellular call is received by the public cellular network 14, which formulates a Setup message that is forwarded (830) through the public cellular network 14 to the service provider network 10. As explained above, the SS7 signaling required for the cellular call setup is well understood by those skilled in the art and not illustrated in detail. On receipt of the Setup message, the service provider network 10 formulates a SIP INVITE message containing the handover number and a service description protocol (SDP) corresponding to the cellular radio of the mobile handset 100, and forwards the SIP INVITE message (832) to the CSN 20. The handover number is associated with the dynamic call anchoring service. Consequently, the CSN 20 uses the calling party number to query (834) the data store 98 in order to retrieve call context information stored at 822.

On receipt to the query message sent by the CSN 20, the data store 98 searches the call context records, as explained above with reference to FIG. 6, and returns (836) the call context information associated with the packet voice connection in session between A-Party and B-Party. On receipt to the query response, the CSN 20 formulates a SIP INVITE message containing the call context information and the SDP of the cellular radio 130, and forwards the SIP INVITE message through the service provider network to the IP/PBX 90 (838). As explained above, the SIP INVITE message is structured in a standardized or a proprietary way to invoke the replaces functionality in the IP/PBX 90. On receipt of the SIP INVITE message, the IP/PBX 90 responds with a SIP 100 trying message (840). After analyzing the SIP INVITE message, the IP/PBX 90 releases the packet voice connection to the IP/WiFi device 99 by sending a SIP BYE (842) to the IP/WiFi device 99. The IP/WiFi device 99 responds with a SIP 200 OK message (844) and the packet voice connection is torn down.

The IP/PBX 90 then formulates a SIP 200 OK message containing the SDP of the IP/PBX 90 and forwards the message (846) to the CSN 20. Meanwhile, the IP/WiFi device 99 formulates a DCA cleanup message which it sends (848) to the data store 98. The data store 98 responds by discarding the call context information associated with the torn down packet voice connection between A-Party and B-Party. Simultaneously, the CSN 20 responds to the IP/PBX 90 with a SIP ACK message (852), and sends a SIP 200 OK message containing the SDP of the IP/PBX 92 the service provider network 10 (854). The service provider network 10 responds with a SIP ACK message (856) and a voice connection is reestablished between A-Party and B-Party (858). As explained above with reference to FIGS. 7 and 8, the CSN 20 then serves as a proxy to the mobile handset 100 and formulates a DCA message containing the call context information associated with dialog 4 and sends the DCA message (860) to the data store 98. Meanwhile, the mobile handset 100 queues (862) a DCA message containing the call context information associated with dialog 4, which will be transmitted if a data channel becomes available.

The invention thereby provides simple, reliable and economical methods for permitting service providers to support dynamic call anchoring on an on-demand basis in order to provide enhanced call features to enterprise customers with limited telephone service termination hardware resources and/or IP bandwidth, without undue network overhead or pre-provisioning.

The invention also reduces capital investment and bandwidth service fee requirements on the part of service subscribers by dynamically anchoring calls in accordance with policy established to meet the specific needs of each enterprise subscriber.

It should be understood that although the invention has been described with reference to a dedicated data store 98, this is not necessary. For example, call context information can simply be synchronized between the mobile handset 100, or any other device used by the subscriber, and the CSN 20, in which case a dedicated data store 98 is not required. The synchronization of call context information between the mobile handset 100 and the CSN 20 can be accomplished using algorithms that are well known in the art.

It should also be understood that the above-described networks, equipment and algorithms are exemplary only, and that dynamic call anchoring in accordance with the invention can be supported between an enterprise network and any other network, including: another enterprise network; a service provider network; a PLMN; or the like. The scope of the invention is therefore intended to be limited solely by the scope of the appended claims.

We claim:

1. A method of dynamic call anchoring to support call continuity for a subscriber who roams between an enterprise network and another network, comprising:
on call setup between a device operated by the subscriber and a device operated by another party, storing call context information about the call so that the call context information is available to be retrieved via a data network by an authorized application that requires the call context information when criteria are satisfied for a handover of the call form the enterprise network to the other network or from the other network to the enterprise network;
when the criteria are satisfied, retrieving the call context information and formulating a call setup message to release the call from the one network and dynamically anchor the call in the other network without disconnecting the device operated by the other party, by using the call context information to invoke a replaces functionality in a switch in the enterprise network.

2. The method as claimed in claim 1 wherein storing call context information comprises sending the call context information from the device operated by the subscriber to a data store using any data channel available to the device operated by the subscriber.

3. The method as claimed in claim 1 wherein formulating the call setup message comprises:
launching a cellular call from a device operated by the subscriber to a handover number associated with a converged services node in a service provider network;
receiving the call setup message at the converged services node;
retrieving the stored call context information;
formulating a SIP INVITE message to invoke the replaces functionality to replace a packet voice connection to the device operated by the subscriber with a cellular connection to the device from which the cellular call was launched; and
sending the SIP INVITE message from the converged services node to the switch in the enterprise network.

4. The method as claimed in claim 3 wherein on receipt of the SIP INVITE message the switch in the enterprise network replaces the packet voice connection with the cellular call without disconnecting the device operated by the other party.

5. The method as claimed in claim 1 wherein sending the call setup message comprises formulating a SIP INVITE message to invoke the replaces functionality using the call context information when criteria for a handover of the subscriber from a cellular connection to a packet connection are satisfied, and sending the SIP invite message from a device operated by the subscriber in the enterprise network to the switch in the enterprise network.

6. The method as claimed in claim 5 wherein on receipt of the SIP INVITE message, the switch in the enterprise network replaces the call in progress to the subscriber with a packet connection to the device operated by the subscriber in the enterprise network.

7. The method as claimed in claim 6 wherein the switch in the enterprise network releases the call in progress and provides a session description protocol to the device operated by the subscriber in the enterprise network.

8. The method as claimed in claim 2 wherein storing the call context information comprises formulating a dynamic call anchoring (DCA) information message containing the call context information and sending the DCA information message to a data store.

9. The method as claimed in claim 8 further comprising formulating a DCA cleanup message that is sent to the data store each time a call connection to a device operated by the subscriber is terminated.

10. The method as claimed in claim 2 wherein storing the call context information comprises:
synchronizing the call context information between the device operated by the subscriber the data store; and
synchronizing the call context information between a converged services node, which acts as a proxy for the device operated by the subscriber, and the data store.

11. A system for dynamically anchoring selected calls to support call continuity for a subscriber who roams between an enterprise network and another network, comprising:
an application client executed by communications devices operated by the subscriber, the application client being programmed to collect call context information respecting calls set up to/from the subscriber and to store the call context information in a data store;
and
a converged services node in a service provider network, comprising a dynamic call anchoring application programmed to: retrieve the call context information from the data store; to formulate a call setup message containing the call context information to invoke replaces functionality in a switch in the enterprise network when handover of a call to/from the subscriber is required; and, to forward the call setup message to the switch in the enterprise network.

12. The system as claimed in claim 11 wherein the application client executes on a dual-mode mobile handset and comprises program instructions for monitoring a signal strength and connectivity associated with each of the enterprise network and the other network to determine when criteria for a handover from the enterprise network to the service provider network or from the service provider network to the enterprise network have been satisfied.

13. The system as claimed in claim 10 wherein the application client further comprises program instructions for consulting policy to determine when criteria for handover from the enterprise network to the service provider network or from the service provider network to the enterprise network have been satisfied.

14. The system as claimed in claim 10 wherein the application client further comprises program instructions for launching a packet call using a SIP INVITE message containing the call context information to invoke replaces functionality in the switch in the enterprise network when the criteria are satisfied for handover of a call from the service provider network to the enterprise network.

15. The system as claimed in claim 10 wherein the application client further comprises program instructions for launching a cellular call to a handover number associated with the converged services node when the criteria are satisfied for handover of a call from the enterprise network to the service provider network.

16. The system as claimed in claim 10 wherein the application client further comprises program instructions for requesting that the switch in the enterprise network transfer a call set up to/from the subscriber to a number associated with a converged services node in the service provider network when the criteria for handover of the call from the enterprise network to the service provider network are satisfied, and for launching a call through to the converged services node; and, the dynamic call anchoring application further comprises program instructions for correlating the transferred call with the launched call, and for sending a SIP (re)INVITE message to the switch in the enterprise network to connect the transferred call to the launched call.

17. An application client for dynamically anchoring selected calls to support call continuity for a subscriber who roams between an enterprise network and another network, comprising:
program instructions for collecting call context information when a call is set up to/from the subscriber and program instructions for storing the call context information; and
program instructions for launching a call setup message when criteria are satisfied for handover of a call from the enterprise network to the other network or handover of the call from the other network to the enterprise network.

18. The application client as claimed in claim 16 further comprising program instructions for sending a call context cleanup message to a data store when a call associated with the call context information is torn down.

19. The application client as claimed in claim 16 wherein the application client executes on a dual-mode mobile handset and comprises program instructions for monitoring a signal strength and a network connectivity associated with each of the enterprise network and the other network to determine when criteria for a handover from the enterprise network to the other network or from the other network to the enterprise network have been satisfied.

20. The application client as claimed in claim 16 further comprising program instructions for launching a packet call to a switch in the enterprise network to invoke replaces functionality in the switch when the criteria are satisfied for handover to the enterprise network of a call set up through the enterprise network and the other network to a device operated by the subscriber.

21. The application client as claimed in claim 16 further comprising program instructions for requesting that the switch in the enterprise network transfer a call set up to/from the subscriber to a number associated with a converged services node in a service provider network when the criteria for handover of the call from the enterprise network to the other network are satisfied, and for launching a call to the converged services node through the other network when the criteria for handover of the call from the enterprise network to the other network have been satisfied.
